(19) United States
(12) Patent Application Publication
(10) Pub. No.: US 2025/0385532 A1
(43) Pub. Date: Dec. 18, 2025

(54) METHOD FOR MANAGING THE ENERGY OF AN ELECTRONIC DEVICE, DEVICE, AND CORRESPONDING COMPUTER PROGRAM

(71) Applicant: ORANGE, Issy-les-Moulineaux (FR)

(72) Inventor: David Excoffier, Châtillon (FR)

(21) Appl. No.: 18/878,720

(22) PCT Filed: Jun. 26, 2023
(86) PCT No.: PCT/EP2023/067305

§ 371 Date: Dec. 24, 2024

(30) Foreign Application Priority Data
Jun. 28, 2022 (FR) 2206487

(51) Int. Cl. H02J 7/00; H02J 7/35

(52) U.S. Cl. CPC H02J 7/0071; H02J 7/35

(57) ABSTRACT

A method for managing the energy of an electronic device. The method includes obtaining at least one action to be carried out by the device, and scheduling execution of the at least one action taking into account a current energy level of the device.

### 1. TECHNICAL FIELD

The field of the invention is that of electronic devices, belonging in particular to the Internet of Things (or loT) or designed specifically for some types of activities (work at height).

More particularly, the invention relates to the energy consumption of such devices, and in particular to the management of the energy consumed by a device to perform one or more action(s).

More generally, the invention relates to any autonomous electronic device, i.e. not powered by a constant energy source (like the power grid), powered with a rechargeable or non-rechargeable energy source (cell, battery, accumulator, etc.), and embedded, or not, in the device. Such a device may possibly cooperate with at least one energy conversion element able to capture ambient energy in order to be able to operate and/or recharge the energy source powering the device. The device may be stationary (a weather station for example) or movable (a car for example).

### 2. PRIOR ART

The use of such electronic devices, commonly so-called “connected objects” or “communicating objects” in the field of IoT, is increasingly widespread. For example, such objects may be used to perform computation operations, store a piece of data, measure a value in the environment (temperature, humidity, presence, etc.) via an embedded sensor, relay measurements output by a sensor, capture a photograph (for example for monitoring a site), communicate data to a remote device, etc.

These objects may be powered in various ways: constant power supply on an electrical outlet (also so-called mains connection), supply with power on a fixed energy reserve (batteries, cells) which could be rechargeable or not, supply with power thanks to an ambient energy (solar, vibrations, temperature differences, etc.), or a mixed power supply between these different supply modes.

These objects may be used in various ways: some could operate occasionally and others on a regular basis, some benefit from large processing capabilities and others not, some perform tasks consuming computing power and others not, etc. Therefore, all of the connected objects do not require the same energy input to operate.

Conventionally, an object may be programmed to carry out one or more action(s) periodically, or according to some internal or external events (sensing a temperature, measuring the insolation level, sending data to a third-party device, performing calculations, etc.). These configurations (type of actions, frequency or cadence of execution—for example every 15 minutes, once per hour, etc.) are generally parameterized in factory, during the manufacture of the object. The user of the object or a trusted third party could possibly modify the factory pre-configuration during installation or use of the object, for example by modifying the cadence of execution of the actions (for example by increasing the frequency of measurement to one every 5 minutes, to the detriment of the duration of operation of the object (and therefore of its service life if it is not rechargeable), or on the contrary by decreasing the frequency of measurement).

The execution of an action consumes a given amount of energy, i.e. has an energy cost. In particular, the type of actions to be carried out, their frequency, etc., could lead to a consumption of all of the energy available for an object, which could result in a stoppage of the object, which de facto is no longer capable of supplying the service(s) for which it is provided.

In particular, each action consumes the available energy in the form of at least one consumption peak, substantially high, and over a substantially long period. For example, FIG. 1 illustrates the consumption related to the capture of a photograph with flash with a digital camera, in ampere over time. According to this example, the first consumption peak 11 corresponds to turning on of the camera (“ON”), the second peak 12 to turning on of the screen, the third peak 13 to the photograph capture, the fourth peak 14 to charging of the flash, and the fifth peak 15 to turning off of the camera (“OFF”).

One could notice that the battery/the cells are highly loaded in terms of energy over short time periods, with very large variations, which affects their service life. As already indicated, the type of actions to be carried out, their frequency, etc., could lead to a consumption of all of the energy available for an object, which could lead to stoppage of the object.

Hence, there is a need for a new technique for managing the energy of connected objects, or more generally electronic devices, which does not have all of the drawbacks of the prior art.

### 3. DISCLOSURE OF THE INVENTION

The present application proposes a solution for managing the energy of an electronic device, in the form of a method comprising:
obtaining at least one action to be performed by said device,
scheduling the execution of said at least one action while taking into account a current energy level of said device.

In particular, the present application relates to a method for managing the energy of an electronic device, comprising:
obtaining at least one action to be performed by said device,
scheduling the execution of said at least one action while taking into account a current energy level of said device, said scheduling taking into account an energy charging capacity of said device taking into account at least one first event external to said device.

According to the invention, a device could thus automatically adapt its behavior, i.e. the execution of the action(s) that it has to perform, while taking into account its energy level. In this manner, the device could, for example, maintain a sufficient energy reserve to operate longer than when guaranteeing the same behavior.

In particular, the invention proposes modifying, where necessary, the “factory pre-configuration” of the device or the configuration performed by a user (hereinafter so-called initial configuration), to adapt the order, the frequency, the time of execution, the number, etc., of the actions that it should carry out, in particular by alternating the phases of executing the actions and the recharging phases in the case of a rechargeable device, so that the device does not consume all of its energy reserve, for example, so as to remain constantly in operation (and possibly to have this energy reserve available in case of detection of an “exceptional” situation to be urgently treated). As examples, an exceptional situation may be the detection of an intruder when monitoring a site by means of a camera and the need to transmit this information to the user or at a security company, a sudden storm which darkens the sky and prevent charging the device by solar energy, etc.

According to at least one embodiment, the proposed solution could thus help extend the operation duration (or service life) of a device powered by any type of energy, belonging for example to the IoT, by enabling the device to adapt automatically and at any time point its preconfigured action capabilities (initial configuration) to its available energy reserve, i.e. enabling this device to adapt automatically to its energy capacity.

By “current energy level” of the device, it should herein be understood the electrical charge level in reserve at the current time point (for example stored in at least one energy storage element, like a non-rechargeable cell, a rechargeable cell, a battery, an accumulator, etc.) and/or powered at the current time point by at least one external energy source, in particular an ambient energy (for example solar, wind, hydraulic, thermal, vibratory, kinetic energy, etc.).

Indeed, a device may be powered in various ways: supply with power from fixed energy reserve (batteries, cells) which could be rechargeable or not, supply with power thanks to ambient energy (solar, vibrations, temperature differences, or any other type of ambient energy, etc.), or a mixed power supply between these different power supply modes or others to come.

Thus, an energy source may be used to directly power the device (totally or partially) and/or to charge/recharge the energy storage element(s) powering the device (totally or partially). Such energy storage elements may be integrated into the device, or be external to this device.

Hence, a rechargeable device is a device using at least one rechargeable energy storage element (rechargeable cell, battery, accumulator, etc.). A rechargeable energy storage element could be charged by converting into electrical energy all or part of an energy available in the environment near the device (“renewable” or “ambient” energy), by being plugged to the mains outlet, etc. Next, the terms charging or recharging the device, and charging or recharging the energy storage element are used interchangeably.

According to a particular embodiment, said scheduling implements:
executing said at least one action for a first duration or as long as the current energy level of said device is higher than or equal to a first energy level, and
timing the execution of said at least one action for a second duration or until the current energy level of said device is higher than or equal to a second energy level.

For example, said second energy level may be higher than said first energy level. For example, the first and/or second energy levels may be threshold levels.

Thus, some actions may be executed for a given time period, or as long as the current energy level of the device is higher than or equal to a first energy level, also so-called the low energy threshold later on.

If the current energy level falls below this first energy level, or after a first time period, the execution of the actions may be deferred. The interruption of the execution of the actions can help reduce the energy consumption of the device. During this interruption, the energy storage element(s) used to power the device may be charged.

Thus, some actions may be paused or put on hold for a second time period, or as long as the current energy level of the device has not become again higher than or equal to a second energy level, also so-called high energy threshold hereinafter, or is not fully charged.

These first and/or second energy levels (high threshold and/or low threshold for example) may be fixed, or vary over time according to the configuration, the actions to be carried out, or any other setting.

In particular, the execution of the actions may be organized so as to take into account times conducive to charging of the device, in particular when the device (or more specifically the energy storage element(s) used to power the device) is charged by converting an energy available in its near environment.

According to a particular embodiment, said execution executes said at least one action with a second frequency, higher than a first frequency, and/or with a second rate, higher than a first rate as long as the current energy level of said device is higher than or equal to said first energy level.

For example, the first frequency and/or the first rate may correspond to guaranteed values, which correspond for example to factory configurations for actions like reading temperature, capturing photographs, transmission of this information, etc. As long as the current energy level of said device is higher than or equal to the first energy level (low energy threshold for example), according to this embodiment, the invention proposes executing some actions at a second frequency (higher than the first frequency) and/or with a second rate (higher than the first rate), i.e. executing these actions more often and/or more quickly.

In a particular embodiment, said scheduling defines an order of execution of said at least one action while taking into account at least one priority associated with said at least one action.

In particular, said scheduling defines an order of execution of at least two actions while taking into account at least one priority associated with said at least two actions.

Thus, a priority action could be executed, and a less priority action could be put on hold. For example, an action like reading temperature could be executed, and an action like transmitting the temperature readings could be deferred as long as the current energy level of the device has not passed over the second energy level (high energy threshold for example).

Thus, the second energy level may correspond to an energy level higher than the first energy level.

In another particular embodiment, said scheduling defines an order of execution of said at least one action while taking into account at least one energy consumption associated with said at least one action.

Thus, an action that consumes a lot of energy could be executed if the current energy level enables the execution of this action (if the current energy level is for example higher than the second energy level), or otherwise deferred. For example, actions that consume less energy are implemented if the current energy level is between the first energy level and the second energy level.

In a particular embodiment, said scheduling times the execution of at least one action amongst said at least one action while taking into account at least one second event external to said device.

In particular, when the device is directly powered using an ambient energy and/or when the energy storage element(s) is/are charged using an ambient energy, charging of the device may be favored with respect to the execution of at least one action when the charging conditions are favorable (for example the presence of wind if the ambient energy is a wind energy, presence of sunlight if the ambient energy is solar energy, etc.). In this manner, it is possible to assist in charging of the device (for example, optimizing charging of the device).

In a particular embodiment, said method determines at least one time range for recharging said device with energy, while taking into account said at least one first event external to said device.

In particular, when the device is directly powered using an ambient energy and/or when the energy storage element(s) is/are charged using an ambient energy, it is possible to take into account event(s) that are external to the device in order to determine at least one time range favorable to charging of the device. For example, it is possible to take into account the sunrise time, possibly while taking into account the geographical position of the device, to switch into the charging mode at the sunrise time.

For example, said first and/or second external event belongs to the group comprising:
a weather condition,
a sunrise and/or sunset time,
an event influencing an ambient energy that could be used to charge said device with energy.

Thus, obtaining a weather condition (for example a wind decrease, the presence of clouds, a temperature difference, etc.), a sunrise and/or sunset time, or more generally of an event influencing an ambient energy that could be used to recharge the device with energy, allows in particular determining whether the conditions are favorable for charging the device with energy. If so is the case, the action(s) to be executed may be put on hold and charging of the device is favored. Conversely, if the conditions are not favorable for charging of the device with energy, some actions could be executed if the current energy level is higher than the first energy level, or deferred otherwise.

In particular, such an external event may depend on the geographical position of the device and/or its energy storage elements.

In a particular embodiment, the method comprises configuring at least one behavior profile of said device, and said scheduling takes into account said behavior profile.

For example, different behavior profiles may be configured. The device could then automatically select at least one behavior profile from among the behavior profiles configured beforehand, while taking into account the different actions to be carried out and its current energy level. The selection of the behavior profile could be updated on a regular basis or on detection of a particular event (for example movement of the device, change in the orientation of the device, modification of the configuration (modification of the actions or of their frequency, for example), sunrise, sunset, sunshine period, low-luminosity period, etc.).

In a particular embodiment, the method comprises triggering an alert if said current energy level is lower than a third energy level. Thus, a user of the device may be informed when the current energy level is very low. Thus, he/she can intervene to replace the energy storage elements powering the device (for example replacing the cells if the cells batteries are not rechargeable), modify the location and/or the orientation of the device so that it better captures ambient energy, modify the energy conversion elements used to convert ambient energy to favor energy capture, as described in French patent application FR2202429 filed on Mar. 18, 2022, etc.

For example, the third energy level corresponds to the first energy level (low energy threshold) or to an energy level lower than the first energy level. For example, this may consist of a critical energy level.

In at least one particular embodiment, said first and/or second and/or third levels energy are parameterizable.

In this manner, it is possible to parameterize at least one amongst the energy levels according to the considered application.

Moreover, the invention relates to corresponding electronic device, comprising at least one processor configured to:
obtain at least one action to be performed by said device,
schedule the execution of said at least one action while taking into account a current energy level of said device.

In particular, the present application relates to a corresponding electronic device, comprising at least one processor configured to:
obtain at least one action to be performed by said device,
schedule the execution of said at least one action while taking into account a current energy level of said device, said scheduling taking into account an energy charging capacity of said device taking into account at least one first event external to said device.

In particular, such a device is suited to the implementation of the steps of the previously-described method in any one of its embodiments. Of course, such a device could include the different features relating to the method according to the invention, which may be combined or considered separately. Thus, the features and advantages of this device are the same as those of the method. Consequently, they are not detailed further.

An embodiment of the invention also aims to protect one or more computer program(s) including instructions adapted to the implementation of the method according to at least one embodiment of the invention as described hereinabove, when this or these program(s) is/are executed by a processor, as well as at least one computer-readable storage medium including instructions of at least one computer program as mentioned hereinabove.

### 4. LIST OF THE FIGURES

Other features and advantages of the invention will appear more clearly upon reading the following description of at least one embodiment, given merely as an illustrative and non-limiting example, and of the appended drawings, wherein:

FIG. 1, described in connection with the prior art, illustrates the energy consumption related to capturing of a photograph with flash with a digital camera,

FIG. 2 illustrates the main steps implemented by a method for managing the energy of a device according to at least one embodiment of the invention,

FIG. 3 illustrates an example of a setting of different energy levels,

FIGS. 4A and 4B illustrate a first example of a behavior profile (asymptotic),

FIG. 5 illustrates a second example of a behavior profile (“intermittent natural consumption”),

FIGS. 6A and 6B illustrate a third example of a behavior profile (“intermittent consumption”),

FIGS. 7A and 7B illustrate a fourth example of a behavior profile (“repetitively braked consumption”),

FIG. 8 illustrates a fifth example of a behavior profile (“day/night”),

FIG. 9 illustrates a sixth example of a behavior profile (“Low luminosity prediction”),

FIGS. 10A and 10B illustrate a seventh example of a behavior profile (“charging in anticipation of an external event”),

FIG. 11 illustrates an eighth example corresponding to a combination of different behavior profiles,

FIG. 12 is a simplified view of electronic device according to at least one embodiment of the invention.

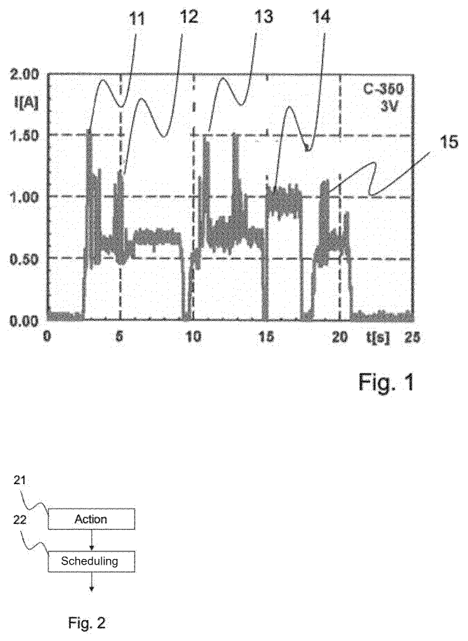

### 5. DESCRIPTION OF AN EMBODIMENT OF THE INVENTION

### 5.1 Reminders

Irrespective of the power mode of a device (cell, battery, ambient energy, or other power supply system), one could distinguish two main types of energy consumption:
the consumption heel, which corresponds to the minimum consumption of the device necessary for operation thereof. In general, this consumption corresponds to the consumption of the electronics of the device and of the embedded software when the device is in the standby mode for example. If the available energy is lower than this consumption heel, the device does not have enough energy to operate;
the rest of the consumption, above the heel, which allows making the device operate with a factory setting or carried out by an a posteriori configuration. This consumed energy may be variable (depending on the type of actions to be performed, their frequency(ies), etc. parameterized for example during the factory pre-configuration or by a trusted user or third party). Each specific action involves an additional energy consumption.

In order to extend the duration of operation of a device, a first solution consists in reducing the “consumption heel”. To do so, it is for example possible to optimize the electrical and/or electronic portion of the device by selecting for example very energy-efficient components allowing reducing the consumption. Alternatively or complementarily, it is possible to optimize the software portion embedded in the device, which could represent a major electrical consumption source (for example because of endless loops, numerous exchanges of messages, etc.).

A second solution, object of the invention, consists in limiting (for example optimizing) the “rest of the consumption”, as described hereinafter. In particular, this second solution may be combined with the first solution proposed hereinabove.

In particular, as indicated hereinabove, the energy consumed in the “rest of the consumption” may be variable (depending on the type of actions to be performed, their number, their duration, their frequency, etc.).

The Inventors have noticed that the initial configuration (pre-configuration factory or configuration by a user or a trusted third party) generally does not pose any problem when the device has a sufficient amount of energy to execute the initially configured actions, for example when it is permanently powered by an electrical outlet, a battery or a powerful cell, or an energy that allows charging the cells or batteries on a regular basis.

On the other hand, when the device is powered by an intermittent energy (case of ambient energies of the solar type, vibrations, etc.) and/or when this device has only a limited energy storage capacity because of the size of its internal battery, or of the wear of its cell, for example, the device does not always have a sufficient amount of energy to execute the (pre-)configured actions.

Indeed, the configuration of the device having been fixed beforehand, the initial configuration according to the prior art requires the device to perform the initially configured actions, for example, to continue reading a value every X seconds, irrespective of the state of its energy reserves. The initial configuration being static irrespective of the state of the device, it will de facto drastically reduce the operation time of the device by forcing the latter to continue reading a piece of data every X seconds without being concerned with its remaining energy, until its energy reserve is completely depleted, or its energy reserve no longer allows supplying enough energy to power the consumption heel (which, as reminder, corresponds to the minimum consumption allowing operation thereof).

### 5.2 General Principle of the Invention

The general principle of the invention is based on monitoring of the energy level of a fixed or movable device, and the organization of the actions that the device has to perform while taking into account the current energy level of the device and these actions (execution of an action or putting on hold, order of execution of the actions, etc.). For example, such actions are “read a value originating from a temperature sensor every X seconds, or Y minutes”, “send a message to a third-party device if a value is lower than or higher than a given configured threshold”, “display a message when the device receives a particular message”, “perform a specific calculation at each new temperature value”, “capture a photograph”, or any other action that could be configured.

In other words, the present invention provides an electronic device, powered by any type of energy, capable of automatically adapting the actions that it should carry out according to its current energy level, so as to optimize these actions according to its own energy reserve and/or the energy supplied at the current time point. Thus, the proposed solution allows correlating the actions that a device should carry out with the capabilities of the device to carry out these actions, in particular its energy capacity.

According to a particular embodiment, the proposed solution allows in particular modifying the initial configuration and adjusting it automatically according to the available/remaining energy. Thus, the current energy level of the device is taken into account to schedule the different actions, which helps maintaining a sufficient energy reserve for the device so as to be able to operate for a long time. In other words, the proposed solution enables the device not to consume all of its energy reserve, which allows extending its operation duration.

Thus, the proposed solution contributes to the extension of the operation time (or service life) of the device, whether the device is supplied with energy by non-rechargeable cells or by rechargeable energy storage elements, or directly by an external energy source, in particular an ambient energy.

In particular, to help extend the operation time of a device, it is possible to integrate capabilities into the latter for capturing the energy available in its near environment, like solar energy for example. Between two actions (reading of a sensor piece of data, image capture, calculation, etc.), the captured solar energy may be used to charge the device, and (in the ideal) sufficiently raise the energy reserve of the device so that this energy reserve is not depleted on the long run.

FIG. 2 illustrates the main steps implemented by a method for managing the energy of a device. It is considered that such a device should carry out different tasks or actions on a substantially regular basis.

During a first step 21, at least one action to be performed by said device is obtained. For example, such actions are obtained based on the factory configuration, or at least one configuration performed by the user or a trusted third party (initial configuration). For example, these actions are parameterized via a menu or a setting option in which, for example, the frequency, the number of times, or the triggering element that allows carrying out this or these task(s) are indicated.

The scheduling of the execution of said at least one action is then implemented during a second step 22, while taking into account a current energy level of the device. Thus, instead of performing the actions according to the initial configuration, the order and/or the cadence and/or the rate, etc., of execution of these actions may be adapted as the device while taking into account the current energy level of the device.

In particular, in some embodiments, the actions may be carried out according to the initial configuration if the current energy level allows so. Otherwise, the actions may be reorganized, by modifying, for example, the order and/or the frequency and/or by timing some actions. In some embodiments, if the current energy level allows so (if it is higher than a high threshold for example), the actions may be reorganized, by increasing for example the frequency of some actions with respect to the initial configuration. According to a particular embodiment, different behavior profiles may in particular be configured according to the invention, and stored in a behavior profile database. The device could then select at least one behavior profile from among the profiles of the database, while taking into account its environment for example.

### 5.3 Examples of Implementation

Different examples of implementation of the invention are described hereinafter. For example, a device configured, for example via a human-machine interface coupled (locally or remotely) to the device, is considered, so that the device makes luminosity, temperature measurements and captures a photograph every two minutes. To do so, the device is in communication with different sensors, integrated into the device or external, in particular a luminosity sensor, a temperature sensor and a camera. For example, the device is supplied with energy by a battery.

Conventionally, such an initial configuration is fixed.

On the contrary, according to the invention, the luminosity, temperature measurements and the photograph capture are scheduled while taking into account the energy level of the device.

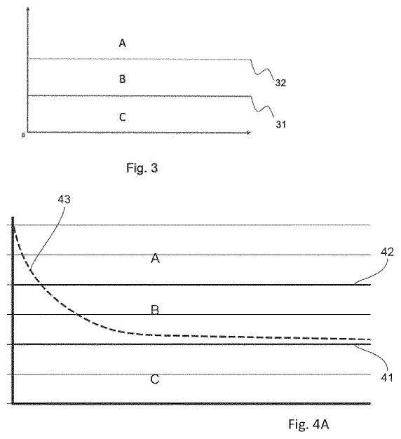

In a particular embodiment, illustrated in FIG. 3, the invention enables the user of the device, the device itself, a trusted third party, or a third-party device, to parameterize at least one energy level as a function of time, for example:
a first energy level 31, also so-called low energy threshold for example, corresponding in some embodiments to an energy level (for example a minimum charge level of the device) below which the consumption of the device should avoid falling (it may be equivalent to the consumption heel for example, or to any value higher than this heel), and/or
a second energy level 32, also so-called high energy threshold for example, corresponding in some embodiments to an energy level (for example a maximum charge level of the device), above which the device could possibly operate in a more energy-intensive manner, at a higher rate and/or frequency compared to the initial configuration (for example luminosity, temperature measurements and photograph capture at a rate higher than 2 seconds).

In particular, the device can measure, or obtain via a third-party device, its current energy level, for example the charge level of the battery. For example, such a measurement is performed using a component for measuring voltage and current, and/or directly power, for example an integrated circuit like the INA233 type integrated circuit from Texas Instruments®. Such a component may be mounted in the device or in a third-party device coupled to the latter.

The device can also determine, or obtain via a third-party device, a maximum charge level of the battery, possibly as well as an optimum operating range (for example comprised between ⅓ and ⅔ of the maximum charge of the battery).

Thus, it is possible to distinguish different areas, depending on the number of parameterized energy levels, in some embodiments. For example, according to the example illustrated in FIG. 3, one could distinguish three area:
area A: above the high energy threshold 32,
area B: between the high energy threshold 32 and the low energy threshold 31, corresponding for example to the optimum operating range,
area C: below the low energy threshold 31.

If one single energy level is parameterized, for example a low energy threshold, only two areas are distinguished: an area above the low energy threshold 31, and an area below the low energy threshold 31.

According to some embodiments, the energy level(s) may be absolute magnitudes. According to other level(s) may be relative embodiments, the energy magnitudes, corresponding, for example, to a charging percentage of the device. In particular, these different embodiments may be combined.

It should be noted that the selection of these energy levels allows defining substantially long timing periods of the actions allowing charging the device.

Thus, according to a particular embodiment, the invention allows defining or selecting an expected behavior profile according to the current energy level of the device and some parameters of the initial configuration, possibly from among a set of pre-existing behavior profiles for this device. In particular, it is possible to combine several behavior profiles in order to create more complex behaviors.

Different behavior profiles according to an embodiment of the invention are described hereinafter.

### 5.3.1 Behavior Profiles Related to the Actions, for a Device That Could Be Rechargeable or Not

### 5.3.1.1. “Asymptotic” Behavior Profile

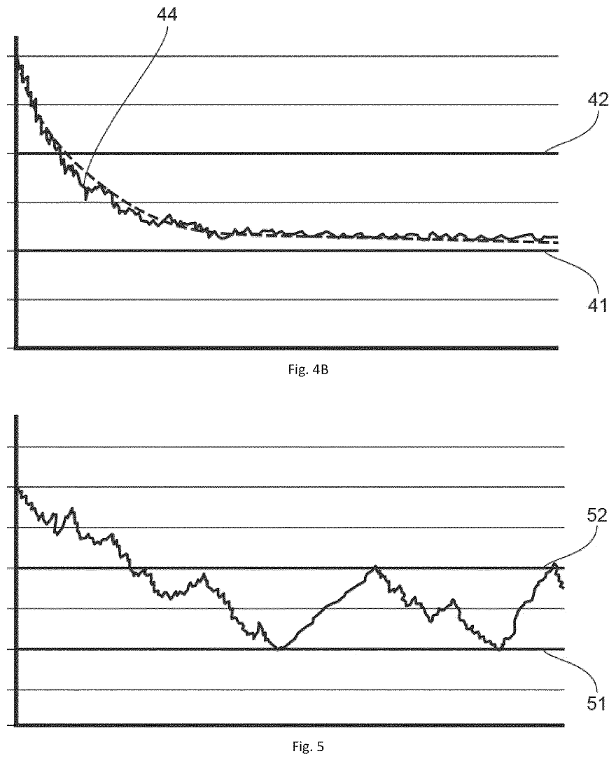

FIG. 4A illustrates a first example of a behavior profile model 43, according to which the current energy level of the energy storage element (cell, battery) of the device decreases over time by following an asymptote.

FIG. 4B illustrates the behavior profile 44 of the device according to this model 43. As long as the current energy level is higher than a high energy threshold 42 (area A), the device has a very active behavior. For example, the device can execute actions with a second frequency higher than a first frequency defined in the initial configuration, and/or a second rate higher than the first rate defined in the initial configuration.

When the current energy level is comprised between the high energy threshold 42 and a low energy threshold 41 (area B), the behavior of the device changes and the actions tend to slow down increasingly over time (for example, reduction of the number and/or frequency of the actions). If the current energy level falls below the low energy threshold 41 (area C), the slowing down of the actions continues, until the device has no more energy (in particular, if the energy storage element is not rechargeable).

An alert may possibly be triggered when the current energy level falls below the low energy threshold 41.

### 5.3.1.2 Behavior Profile According to any Type of Mathematical Curve

In general, it is possible to create different behavior profiles according to which the current energy level of the energy storage element (cell, battery) of the device decreases over time by following a mathematical curve, insofar as the latter corresponds to an equation that could follow a discharge of the device, its maximum charge or a charge corresponding to the high energy threshold at a time point t, towards a zero charge or a charge corresponding to the low energy threshold at a time point t+x.

### 5.3.2 Behavior Profiles Related to the Actions, for a Rechargeable Equipment (for Example With Ambient Energy)

### 5.3.2.1 “Intermittent Natural Consumption” Behavior Profile

FIG. 5 illustrates the current energy level of a device over time, according to which the device behaves in a nominal manner, both when being discharged and when being charged.

As long as the current energy level of the device is higher than or equal to the low energy threshold 51 (or over a first duration D1), the device could execute actions, for example according to the setting of the initial configuration. In other words, according to this so-called “intermittent natural” profile, the device behaves as defined in the initial configuration (factory pre-configuration or user configuration) as long as the energy level does not reach the low energy threshold 51 (or over a first duration D1).

Once the low energy threshold has been reached 51, the device times the execution of at least one of the energy-consuming actions (“standby” mode, or “sleep” mode for example) (for example of one of them, or all of them) and prioritizes charging with energy until reaching the high energy threshold 52, if a high energy threshold 52 is defined (or over a second duration D2). For example, the device is charged using ambient energy (solar, wind, hydraulic, etc.). Once the high energy threshold 52 is reached, the device resets itself to operate in a nominal manner, as defined in the initial configuration as long as the energy level does not reach the low energy threshold 51, and so on.

If no high energy threshold 52 is defined, the device could be charged with energy for a second duration D2, or until a given charge percentage is reached, then it sets itself again to operate in a nominal manner, as defined in the initial configuration, as long as the energy level does not reach the low energy threshold 51, and so on.

Alternatively, this behavior profile may be parameterized to operate between the maximum charge of the energy storage element of the device, and the high energy threshold as a low limit, as illustrated hereinafter in FIG. 11.

In some embodiments, it is in particular possible to lower the high energy threshold and/or to raise the low energy threshold to reduce the time allocated to charging of the energy storage elements, and therefore at timing of the actions. Nonetheless, it should be noted that the shorter the charging time, the more the number of chargings increases, which might have an impact on the service life of the energy storage elements.

### 5.3.2.2 “Intermittent Consumption” Behavior Profile

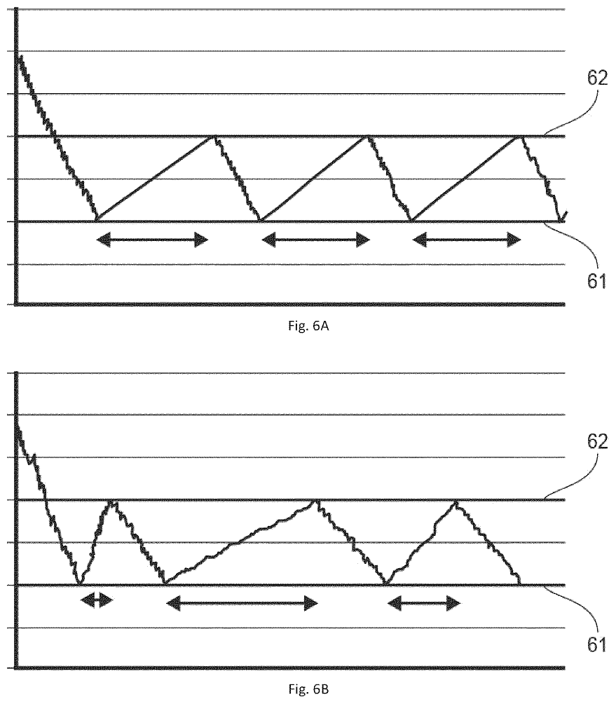

FIGS. 6A and 6B illustrate the current energy level of a device over time, according to which the device behaves in a nominal or accelerated manner during discharge, and uses ambient energy to be charged, for example an artificial light according to FIG. 6A or a natural light according to FIG. 6B.

As long as the current energy level of the device is higher than or equal to the low energy threshold 61 (or over a first duration D1), the device could execute actions for example according to the setting of the initial configuration, i.e. with a first frequency and/or a first rate. Alternatively, the device could execute actions according to a different setting, for example with a second frequency higher than the first frequency and/or a second rate higher than the first rate. Thus, in at least one embodiment, the device could execute the expected actions continuously (“sprinter” mode) (or more rapidly than provided for by its initial configuration) as long as the current energy level of the device is higher than or equal to the low energy threshold 61 (or over a first duration D1).

Once the low energy threshold 61 is reached, the device times the execution of at least one of the energy-consuming actions (“standby” mode) (for example of one of them, or all of them) and prioritizes charging with energy until reaching the high energy threshold 62, if a high energy threshold 62 is defined (or over a second duration D2). For example, the device is charged using artificial or natural light.

The charging time may last for a substantially long time depending on the embodiments, for example depending on the energy conversion system (“energy harvesting”) of the device as well as depending on the environment.

If the device is charged using artificial light, the charging time may be substantially constant, as illustrated in FIG. 6A.

On the other hand, if the device is charged using natural light (the Sun), full-Sun charging could be faster than charging under a cloudy sky, as illustrated in FIG. 6B.

Once the high energy threshold 62 is reached, the device resets itself to operate as defined in the initial configuration or according to another setting (for example execution of the actions continuously, or more rapidly than provided for by its initial configuration), as long as the energy level does not reach the low energy threshold 61, and so on.

If no high energy threshold 62 is defined, the device can be charged with energy for a second duration D2, or until reaching a given charging percentage, then it resets itself to operate as defined in the initial configuration or according to another setting, as long as the energy level does not reach the low energy threshold 61, and so on.

Alternatively, this behavior profile may be parameterized to operate between the maximum charge of the energy storage element of the device and the high energy threshold as a low limit, as illustrated hereinafter in FIG. 11.

As already indicated, in some embodiments, it is possible to lower the high energy threshold and/or to raise the low energy threshold to reduce the time allocated to charging of the energy storage elements, and therefore to timing of the actions.

### 5.3.2.3 “Repetitively Braked Consumption” Behavior Profile

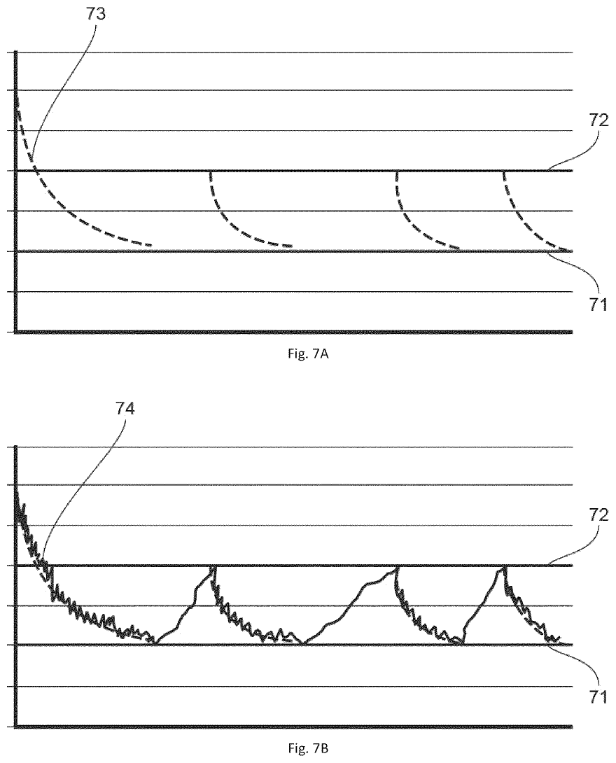

FIG. 7A illustrates a behavior profile model 73 according to which the current energy level of the energy storage element (cell, battery) of the device decreases over time while repetitively following an asymptote, and FIG. 7B illustrates the behavior profile 74 of the device according to this model.

This behavior profile is similar to the asymptotic profile of FIG. 4A, but in a repetitive manner.

As long as the current energy level of the device is higher than or equal to the low energy threshold 71 (or over a first duration D1), the device performs actions, for example according to the initial configuration or according to another setting, such that its consumption curve follows an asymptote.

Once the low energy threshold 71 is reached, the device times the execution of at least one of the energy-consuming actions (“standby” mode) (for example of one of them, or all of them) and prioritizes charging with energy until reaching the high energy threshold 72, if a high energy threshold 72 is defined (or for a second duration D2). Once the high energy threshold 72 is reached, the device resets itself to operate as defined in the initial configuration or according to another setting, such that its consumption curve follows the expected asymptote, as long as the energy level does not reach the low energy threshold 71, and so on.

As already indicated, if no high energy threshold 72 is defined, the device may be charged with energy for a second duration D2, or until reaching a given charge percentage, then it resets itself to operate as defined in the initial configuration or according to another setting, as long as the energy level does not reach the low energy threshold 71, and so on.

As also already indicated, it is possible to lower the high energy threshold and/or to raise the low energy threshold to reduce the time allocated to charging of the storage elements with energy, and therefore to timing of the actions.

### 5.3.2.4 “Lower Consumption” Behavior Profile

According to another behavior profile, the actions that are the most energy-intensive could be put on hold. Thus, an order of execution of the actions is defined while taking into account at least one energy consumption associated with the actions.

For example, it is possible to interrupt or time the execution of the most energy-consuming action, or of a set of the most energy-consuming actions, or of the action(s) whose energy consumption is higher than a given value, etc.

According to a first example, actions related to data transmission and/or reception, which are generally energy-consuming, may be put on hold (for example during nighttime, as described hereinafter). For example, the data to be sent may be stored in a memory of the device for a duration corresponding to the deactivation of the “Send the data” action. These data could be sent later on, for example when the charge level of the device would have risen to an acceptable level.

According to a second example, it is possible to use a specific behavior profile, for example an asymptotic behavior profile as illustrated in FIGS. 4A and 4B, or repetitively asymptotic profile as illustrated in FIGS. 7A and 7B, by executing actions (ordered from the most consuming actions to the least consuming ones) and by reducing the number of actions over time (for example for each asymptote, if a repetitively asymptotic behavior profile is considered).

According to a third example, it is possible to put on hold a large number of actions (for example all those associated with an energy consumption higher than a given value), or to put on hold all actions, while taking into account the current energy level. In particular, it is possible to put on hold some actions until the device recovers a minimum acceptable charge level (for example putting on hold during nighttime, or if the weather is bad and does not allow charging the device).

This reduced consumption type behavior profile allows deactivating or timing at least one action provided for in a nominal mode for the device (i.e. according to the initial configuration), by favoring some actions with respect to others, in order to substantially or progressively reduce the consumption of the device.

### 5.3.3 Time-Based Behavior Profiles

Time-based behavior profiles may also be defined, and may possibly be combined with the behavior profiles related to the actions described hereinabove. These profiles allow differentiating different behaviors related to the actions to be carried out by the device according to specific time criteria (daytime/nighttime, hour, season, etc.), or even more specific time-based predictions (related for example to meteorology). The actions to be carried out are then ordered while taking into account at least one event external to the device, like the season, the day, the time, the weather, etc.

### 5.3.3.1 “Daytime/Nighttime” Time-Based Profile

For many reasons, it might be important to vary the behavior of the device according to use thereof in daytime or in nighttime. This is all the more important when the device is fully or partially powered with an energy available in the near environment (the ambient energy could be used to directly power the device and/or an energy storage element of the device). For example, if the device uses solar energy to function, it is desirable to limit the energy consumption of the device at night.

Thus, the device can obtain at least one piece of information relating to a current time and, in some embodiments, to the sunrise and/or sunset time, depending in particular on the geographical position of the device. For example, the device may embed a solar calendar, obtain this information from a remote device, be subscribed to an ephemeris service, etc.

Hence, this behavior profile allows determining the current time or the sunrise and/or sunset times at the location of the device, and to propose behaviors of the device differentiated according to the time of the day.

As indicated before, it is in particular possible to combine this time-based profile with behavior profiles related to the actions.

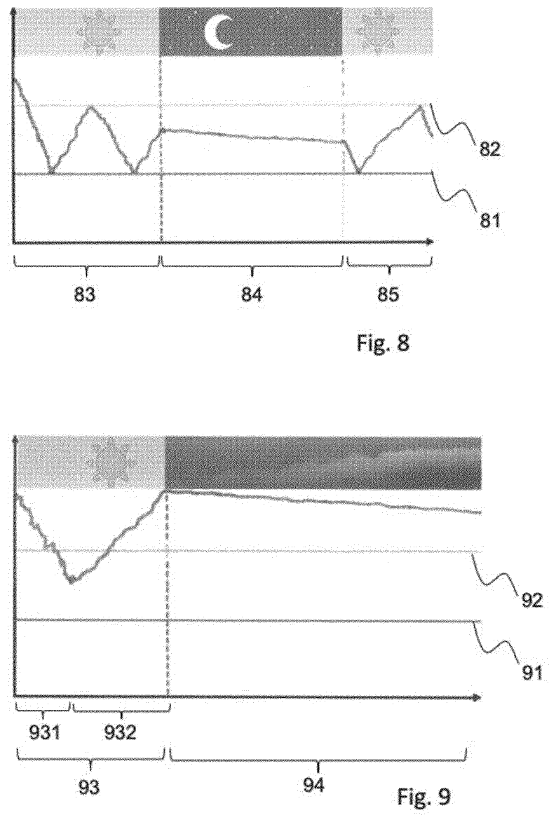

Thus, as illustrated in FIG. 8, one or more behavior profile(s) related to the actions may be implemented during daytime, and possibly one or more behavior profile(s) related to the actions, or a timing of the actions (at least the most energy-consuming actions) may be implemented during nighttime.

For example, an “intermittent (natural) consumption” type behavior profile may be implemented during daytime (83), while taking into account a low energy threshold 81 and/or a high energy threshold 82. During nighttime (84), the actions may be put on hold, or an asymptotic or reduced consumption behavior profile may be implemented for example. When the day comes again (85), an “intermittent (natural) consumption” type behavior profile for example may be implemented again.

### 5.3.3.2 “Low-Luminosity Prediction” Time-Based Profile

Another behavior profile may be defined by taking into account at least one event external to the device, so as, for example, to anticipate difficulties in charging the device.

In particular, when the device uses ambient energy to be charged, it might be important to take into account events that could influence the ambient energy. For example, the behavior profile may take into account, in some embodiments, weather forecasts on the short and/or mid run.

Considering again the example of charging of the device using solar energy, it consists herein in forecasting the low-luminosity periods during the day (cloudy and/or bad weather periods) to anticipate the possible problems of charging of the device. Indeed, in the case of a device having an embedded charging capacity, for example thanks to photovoltaic panels (“energy harvesting”), these low-luminosity periods could considerably increase the time required to charge the device.

Thanks to this prediction of events that could influence the ambient energy, for example by knowing in advance the degradation of the weather, it is possible to automatically change the behavior of the device to anticipate a bad weather period, especially if it is expected to last. In this case, for the device to operate for a long time, it is desirable to charge the device at the maximum level (or at least at the high energy threshold) before the weather degrades. It is also possible to adapt the behavior of the device when it is in a low-luminosity period, for example by making it carry out less actions than in full sunlight in order to save its energy.

In particular, it is possible to determine at least one time range for the charging the device with energy while taking into account the prediction of the event that could influence the ambient energy.

For example, as illustrated in FIG. 9, one or more behavior profile(s) related to the actions may be implemented during the sunshine period, and possibly one or more behavior profile(s) related to the actions, or a timing of the actions (at least the most energy-consuming actions) may be implemented during the bad weather period.

For example, an “intermittent (natural) consumption” type behavior profile may be implemented over a first portion 931 of a sunshine period 93, while taking into account a low energy threshold 91 and/or a high energy threshold 92. If a bad weather period 94 is expected, the device may anticipate this bad weather period and interrupt the execution of the actions to favor charging of the device. For example, by taking into account the current energy level, and weather forecasts, the device can determine at what time it should interrupt the execution of the actions to favor charging thereof (in particular if he/she wishes to reach a full charge before bad weather, a charge equal to the high energy threshold, a given charge percentage, etc.). Thus, a charging period may be implemented over a second portion 932 of the sunshine period 93, according to a low-luminosity prediction time-based profile.

When the bad time arrives (94), some actions may be put on hold, or an asymptotic or reduced consumption behavior profile may be implemented, for example.

More generally, specific time-based profiles may be created for any type of ambient energy and associated “harvester”: prediction of a decrease in the captured energy, for example, via a flow of air (for example, prediction of a drop in wind), of water or of steam, of temperature difference, or by other energy harvesting means in the near environment.

### 5.3.3.3 “Charging in Anticipation of an External Event” Time-Based Profile

In the case of a device having a charging capacity based on ambient energy of the solar type, for example, it might be preferable to charge the device before nighttime (in particular if the next day is cloudy or rainy, which implies a longer charging time than in full sunlight).

The behavior of the device could be differentiated between daytime and nighttime (like according to the “daytime/nighttime” time-based profile), while being assured to have a sufficiently high charge (for example higher than a given value, for example the high energy threshold) before the night falls.

As already indicated with reference to FIG. 8, the device may obtain at least one piece of information relating to the sunrise and/or sunset time, for example by embedding a solar calendar, by interrogating a remote device, by being subscribed to an ephemeris service, or by any other means.

Other variables may also be taken into account by this time-based profile, in particular the geographical position of the device (in the Alps, in Grenoble for example, the surrounding mountains cause the Sun to set earlier than the “official time”), or, for example, forecasting the weather several hours before the sunset time which could considerably affect the charging capacity if the sky is cloud.

Thus, this profile allows predicting, according to some parameters hereinabove or other parameters, at what time point the device should interrupt the execution of the actions to favor charging, which enables the device to operate in a nominal manner during daytime, and to stop at a time point enabling it to have a sufficient charge (for example a maximum charge, a charge equal to the high energy threshold, a given charge percentage, etc.).

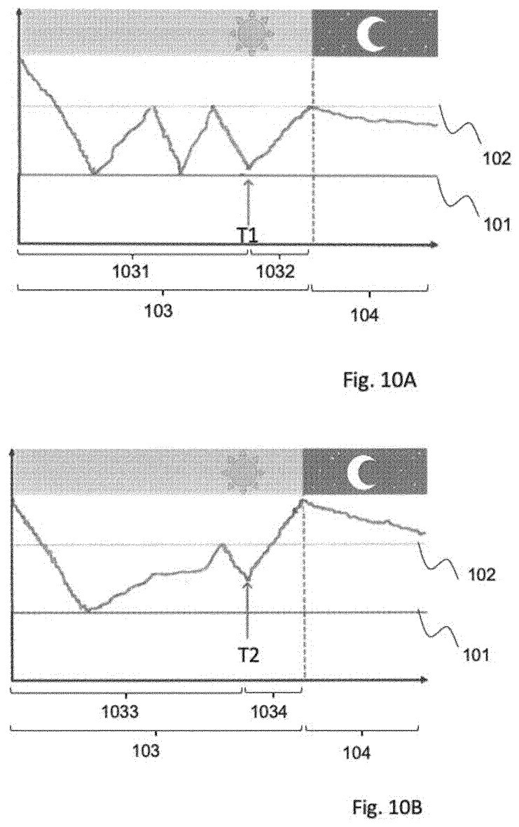

FIGS. 10A and 10B illustrate the current energy level of a device over time (over 24 hours for example), according to which the device determines a time range or a time point from which the device should interrupt the execution of the actions to favor charging thereof.

According to the examples illustrated in FIGS. 10A and 10B, an “intermittent (natural) consumption” type behavior profile may for example be implemented over a first portion (1031, 1033) of the day 103, while taking into account a low energy threshold 101 and/or a high energy threshold 102. Since the device knows the “official” time of the sunset, it can determine, possibly while taking into account other parameters like the geographical position of the device or the weather, the time from which the luminosity will be too low and will no longer enable an optimum charging of the device, and consequently determine at what time point it should interrupt the execution of the actions to favor charging thereof.

This time point depends in particular on the charge that the device wishes to reach before the luminosity is too low.

According to the example illustrated in FIG. 10A, the device is parameterized to reach the high energy threshold 102 before the luminosity is too low. Starting from the time point T1, the device puts on hold the actions that it should perform and switches into the charging mode. Thus, a charging period may be implemented over a second portion 1032 of the day 103. In this manner, the energy level of the device is at the high energy threshold when the luminosity becomes too low (night 104).

According to the example illustrated in FIG. 10B, the device is parameterized to reach a full charge before luminosity is too low. Starting from the time point T2, the device puts on hold the actions that it should perform and switches into the charging mode. Thus, a charging period may be implemented over a second portion 1034 of the day 103. In this manner, the energy level of the device is at the maximum level when the luminosity becomes too low (night 104).

When the night falls (104), the actions could be put on hold. Since the charge level of the device is high, an asymptotic or reduced consumption behavior profile could for example be implemented.

### 5.3.4 Combination of Profiles

The above-described profiles and the features associated with these different profiles, as well as other profiles that are not described, may be combined.

More the invention generally, enables the definition of other behavior profiles related to the actions, other time-based behavior profiles, or other types of behavior profiles. For example, such profiles may be defined and added in a profile base according to the type of the device, the location on the Earth, the climatic conditions, or any other criterion. If the device can be powered or charged by an ambient energy source, this or these criterion/criteria may depend on the type of ambient energy (for example while taking into account a movement or a stoppage of the device if a kinetic energy is considered, a tide, a variation in a current if a hydraulic energy is considered, etc.).

According to some embodiments, the invention thus allows providing a library of behavior profiles, which can evolve, to enable adaptation of the device to its own environment (indoor (in English “indoor”) or outdoor (in English “outdoor”) environment).

Moreover, as already indicated, it is possible to combine different profiles, over the same time range (for example by combining a behavior profile related to the actions and a time-based profile) or over successive time ranges.

Thus, it is possible to favor differentiated behavior profiles between daytime and nighttime, parameterize a preferable profile when the weather is good, another one when the weather is bad, etc. The possible combinations are numerous.

For example, FIG. 11 illustrates the charge level of the device over time, using a combination of “daytime/nighttime” profiles, “low-luminosity prediction” and “charging in anticipation of an external event”.

For example, an “intermittent (natural) consumption” type behavior profile may be implemented over a first portion 1111 of a sunshine period 111. If a bad weather period 112 is expected, the device may implement a “low-luminosity prediction” time-based profile and anticipate this bad weather period by interrupting the execution of the actions to favor charging of the device. For example, while taking into account the current energy level, and the weather forecasts, the device can determine at what time point T3 it should interrupt the execution of the actions to favor charging thereof (in particular if it wishes to reach a charge equal to the high energy threshold according to the illustrated example). Thus, a charging period may be implemented over a second portion 1112 of the sunshine period 111.

When the bad time arrives (112), the actions could be put on hold, or an asymptotic or reduced consumption behavior profile could be implemented, for example. Thus, it is possible to defer the execution of the non-essential actions in bad weather.

When the Sun returns (113), an asymptotic-type behavior profile could then be implemented over a first portion 1131 of the new sunshine period 113.

If the device detects that the night 114 approaches, it may implement a “charging in anticipation of an external event” time-based profile and anticipate this nighttime period by interrupting the execution of the actions to favor charging of the device. For example, while taking into account the current energy level, and the sunset time, the device can determine at what time point T4 it should interrupt the execution of the actions to favor charging thereof (in particular if it wishes to reach a maximum charge according to the illustrated example). Thus, a charging period may be implemented over a second portion 1132 of the new sunshine period 113.

When the night arrives (114), the actions may be put on hold, or an asymptotic behavior profile or reduced consumption may be implemented, for example. Thus, it is possible to reduce the energy consumption of the device during nighttime.

When the day comes (115), a new “intermittent natural consumption” type behavior profile for example could be implemented, and so on.

Thus, according to some embodiments, the invention allows automatically parameterizing the behavior of the device according to its energy level, and possibly its location, the modifications of its own environment, etc., by offering the possibility of selecting profiles favoring a suitable energy consumption, thereby making the device more autonomous and potentially lengthening its service life in comparison with the static setting of the prior art.

Thus, two devices placed at two different locations will not necessarily have the same behavior at the same time point, since the behavior of the device depends on its energy level, which could depend in particular on its environment, its location, etc.

### 5.4 Electronic Device

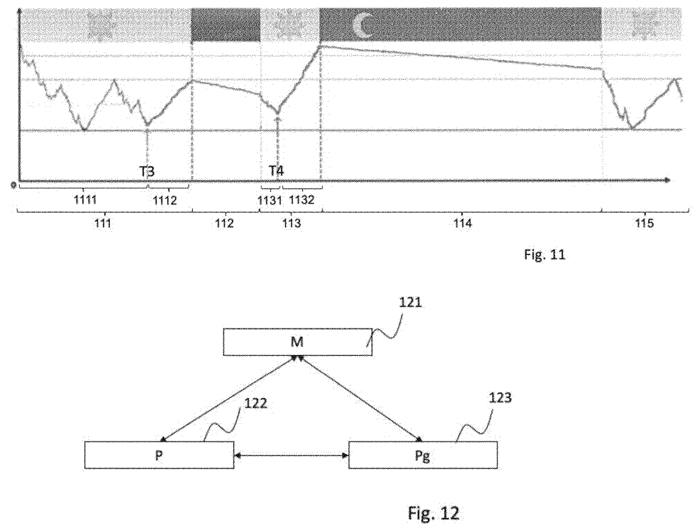

Finally, referring to FIG. 12, the simplified structure of an electronic device according to at least one embodiment of the invention is described.

As illustrated in FIG. 12, a device according to an embodiment of the invention comprises a memory 121, a processing unit 122, equipped for example with a programmable computing machine or a dedicated computing machine, for example a processor P, and controlled by the computer program 123, implementing steps of the method according to at least one embodiment of the invention.

On initialization, the code instructions of the computer program 123 are for example loaded into a RAM memory before being executed by the processor of the processing unit 122.

The processor of the processing unit 122 of the device implements steps of the previously-described method, according to the instructions of the computer program 123, to:
obtain at least one action to be performed by said device,
schedule the execution of said at least one action while taking into account a current energy level of said device.

For example, the processor of the processing unit 122 may implement steps of the previously-described method, according to the instructions of the computer program 123, to:
obtain at least one action to be performed by said device,
schedule the execution of said at least one action while taking into account a current energy level of said device, said scheduling taking into account an energy charging capacity of said device taking into account at least one first event external to said device.

The electronic device may also comprise and/or be coupled to third-party components or equipment enabling measurement of its current energy as well as to controllable third-party components and/or equipment adapted to the implementation of the actions to be carried out (like a temperature sensor for measuring a temperature, or a camera for capturing a photograph for example).

1. A method for managing energy of an electronic device, the method being implemented by the electronic device and comprising:
obtaining at least one action to be performed by said electronic device,; and
scheduling execution of said at least one action while taking into account a current energy level of said electronic device, said scheduling taking into account an energy charging capacity of said electronic device taking into account at least one first event external to said electronic device.

2. The method according to claim 1, wherein said scheduling implements:
executing said at least one action for a first duration or as long as the current energy level of said electronic device is higher than or equal to a first energy level, and
timing the execution of said at least one action for a second duration or until the current energy level of said electronic device is higher than or equal to a second energy level, higher than said first energy level.

3. The method according to claim 2, wherein said execution executes said at least one action with a second frequency, higher than a first frequency, and/or with a higher second rate, higher than a first rate as long as the current energy level of said electronic device is higher than or equal to said first energy level.

4. The method according to claim 1, wherein said scheduling defines an order of execution of at least two actions while taking into account at least one priority associated with said at least two actions.

5. The method according to claim 1, wherein said scheduling defines an order of execution of said at least one action while taking into account at least one energy consumption associated with said at least one action.

6. The method according to claim 1, wherein said scheduling times the execution of at least one action amongst said at least one action while taking into account at least one second event external to said electronic device.

7. The method according to claim 1, wherein said method determines at least one time range for recharging said electronic device with energy, while taking into account said at least one first event external to said electronic device.

8. The method according to claim 7, wherein said first external event belongs to the group consisting of:
a weather condition,
a sunrise and/or sunset time.

9. The method according to claim 1, wherein the method comprises configuring at least one behavior profile of said electronic device, and said scheduling takes into account said behavior profile.

10. The method according to claim 1, wherein the method comprises triggering an alert in response to said current energy level being lower than a third energy level.

11. The method according to claim 2, wherein said first and/or second energy level are parameterizable.

12. The method according to claim 10, wherein said third energy level is parameterizable.

13. An electronic device comprising:
at least one processor configured to:
obtain at least one action to be performed by said electronic device,
schedule execution of said at least one action while taking into account a current energy level of said electronic device, said scheduling taking into account an energy charging capacity of said electronic device taking into account at least one first event external to said electronic device.

14. The electronic device according to claim 13, wherein said at least one processor is configured to determine at least one time range for recharging said device with energy, while taking into account said at least one first event external to said device.

15. A non-transitory computer readable medium comprising instructions stored therein which, when the instructions are executed by at least one processor, cause the at least one processor to implement a method for managing energy of an electronic device, the method comprising:
obtaining at least one action to be performed by the electronic device; and
scheduling execution of said at least one action while taking into account a current energy level of said electronic device, said scheduling taking into account an energy charging capacity of said electronic device taking into account at least one first event external to said electronic device.
